(19) United States
(12) Patent Application Publication
(10) Pub. No.: US 2012/0084072 A1
(43) Pub. Date: Apr. 5, 2012

(54) METHOD AND DEVICE FOR RUNNING LINUX APPLICATION IN ANDROID SYSTEM

(75) Inventors: Fei XUE, Beijing (CN); Fei ZHAO, Beijing (CN)

(73) Assignee: BEIJING BORQS SOFTWARE TECHNOLOGY CO., LTD., Beijing (CN)

(21) Appl. No.: 13/294,075

(22) Filed: Nov. 10, 2011

Related U.S. Application Data
(63) Continuation of application No. PCT/CN2010/077560, filed on Oct. 1, 2010.

(30) Foreign Application Priority Data
Mar. 31, 2010 (CN) 2010-10139435.6

(51) Int. Cl. G06F 9/455

(52) U.S. Cl. 703/27

(57) ABSTRACT

A method and a device for running a Linux application in an Android system are described herein. An Android application proxy processing module can create a shared display area, and the display configuration can be set by a Linux application processing module (i.e., a Linux application) according to the created shared display area to share the display area. The Android application proxy processing module can transmit the received user events to the Linux application processing module for processing. The user interface information created after being processed can be sent by the Linux application processing module to a display module for display.

### CROSS-REFERENCE TO RELATED APPLICATIONS

This application is a continuation of International Patent Application No. PCT/CN2010/077560, filed on Oct. 1, 2010, which claims foreign priority from CN 201010139435.6, filed on Mar. 31, 2010, each of which are incorporated herein by reference in their entirety.

### BACKGROUND

1. Field

The present application relates to the technical field of computer system applications, and in particular to a method and a device for running Linux applications on an Android system.

2. Background

Android is a Linux platform-based open-source cell phone operating system developed by Google, including software for operation of cell phones such as an operating system, a user interface, and application programs, etc. Android can employ a software stack architecture, which can divide into three parts: a bottom layer, which can be based on a Linux kernel, developed in c language, and provide fundamental functions; an intermediate layer, which can include a function library and a virtual machine, and can be developed in C++ language; a top layer, which can comprise application software, including communication program and SMS program, etc. The application software can be developed by various service providers in the Java language, among other languages.

An Android system can provide a Java UI framework and cannot natively include the user interfaces of Linux user interface applications into its own interface system. As a result, the Linux user interface applications cannot run normally in an Android system.

When a Linux user interface application runs in an Android system, the display interface of the Linux application program cannot display normally in some cases. The Android system can take over (even though not all) system display and event transmission, and the display interface controlled by Android system can overlay the display interface of the Linux application program. In addition, since the event information can also be taken over by the Android system, it may not be transmitted to the Linux application program correctly.

When a Linux application runs in an Android system, the display area of the Linux application can be out of the control of the Android system, and the screen display can be disordered. In addition, since the user events can be intercepted by the Android system, the Linux application cannot work normally.

### SUMMARY

In order to solve or at least partially solve the drawbacks described above, methods and systems can be provided for normal running Linux applications in an Android system. In these systems and methods, an Android application proxy processing module can be utilized to create a shared display area as the shared display area for the results of Linux user event processing. The display interface can be managed by the Android application proxy processing module, and the received Linux user events can be transmitted to a Linux application processing module for processing. As a result, in some embodiments, the Linux applications can work normally in the Android system.

In one embodiment, a method for running Linux applications in Android system can include the following steps: creating a shared display area, by an Android application proxy processing module; displaying configuration, by a Linux application processing module; and processing user events and sending user interface information to a display module for displaying.

In another embodiment, a device for running Linux applications in an Android system can include: an Android application proxy processing module; a Linux application processing module; a display module; a Linux system module; and an Android system module. The Android application proxy processing module can be connected with the Android system module and the Linux application processing module, create a shared display area, send shared display information to the Linux application processing module, receive user events sent from the Android system module, and send the user events to Linux application processing module. The Linux application processing module can receive the shared display information and user events sent from the Android application proxy processing module, display configuration, process the user events, and send user interface information to the display module. The display module can receive and display the user interface information sent from the Linux application processing module or Android application proxy processing module. The Linux system module can receive user events and transmit the received user events to the Android system module. The Android system module can transmit the received user events to the Android application proxy processing module.

The present disclosure discusses an Android application proxy processing module that can be utilized to create a shared display area as the shared display area for Linux user event processing. The user events in Linux system and the user events in Android system can be systematically managed by the Android application proxy processing module, so that the Linux applications can run normally in the Android system.

### BRIEF DESCRIPTION OF THE DRAWINGS

The accompanying drawings are provided to help further understanding, and constitute a part of the specification. These drawings are used in conjunction with the embodiments, but do not constitute limitations.

FIG. 1 is a flow diagram of an embodiment of a method for running Linux applications in an Android system;

FIG. 2 is a schematic diagram of an embodiment of an architecture of a device for running Linux applications in an Android system;

FIG. 3 is a schematic diagram of an embodiment of normal running of Linux application modules in a Linux system;

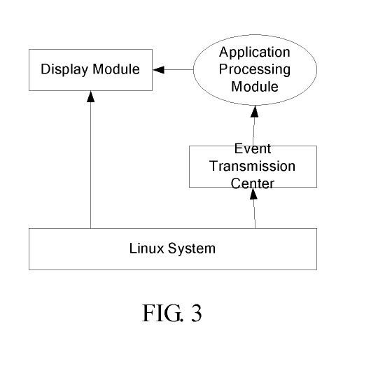

FIG. 4 is a schematic diagram of an embodiment of running existing Linux application modules in an Android system.

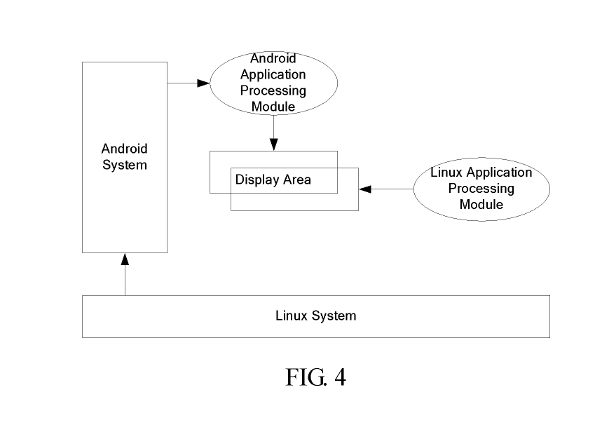

### DETAILED DESCRIPTION

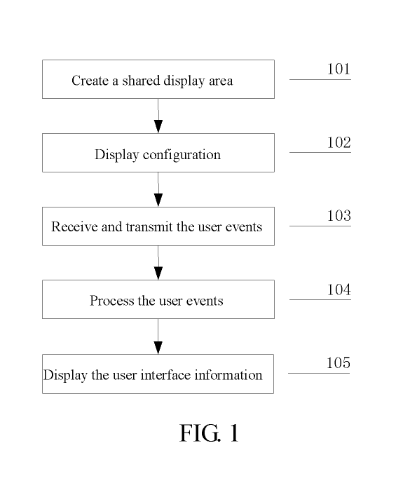

FIG. 1 is a flow diagram of a method for running Linux applications in Android system.

In block 101, an Android application proxy processing module can create a shared display area that can display Linux applications and Android applications, and send the shared display information to the Linux application processing module. The shared display area can be created in at least two ways. One way can include where the Android application proxy processing module can create the area and inform the Linux application processing module, and the latter can direct its display to the area. The other way can be where a default framebuffer of a Linux system can be shared by the two modules. The shared display area can be controlled by the Android application proxy processing module in the form of android.view.Surfaceview control.

In block 102, the Linux application processing module can receive the shared display information sent from the Android application proxy processing module, and display configuration according to the shared display information, for example, directing the display to the area.

In block 103, the Android application proxy processing module can receive user event notification information from an Android system module, and transmit the user events to the Linux application processing module, which can be equivalent to transmit the user events. In some embodiments, the Android application proxy processing module may not process these user events.

In block 104, the Linux application processing module can process the received user events and send user interface information to a display module. The above-mentioned user interface information can include information on user event processing procedure and result that can be displayed by the display module.

In block 105, the display module can receive and display the user interface information sent from the Linux application processing module.

Through the above process, the existence of a proxy (Android application proxy processing module) can be imperceptible to the Linux application processing module when the Linux application processing module runs in the Android system.

Moreover, in some embodiments, the above-mentioned method for running Linux applications in an Android system can be implemented on a device.

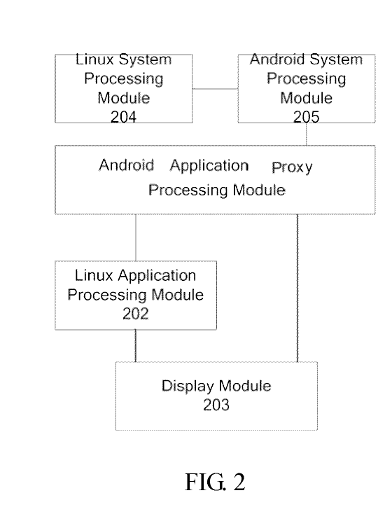

FIG. 2 is a schematic diagram of an embodiment of an architecture of a device for running Linux applications in an Android system. As shown in FIG. 2, the device for running Linux applications in an Android system can include: an Android application proxy processing module 201, a Linux application processing module 202, a display module 203, a Linux system module 204, and an Android system module 205.

In one embodiment, the Android application proxy processing module 201 can be connected with the Android system module 205 and the Linux application processing module 202, create a shared display area, send the shared display information to the Linux application processing module 202, receive user events sent from the Android system module 205, and transmit the user events to the Linux application processing module 202. In addition, the Android application proxy processing module 201 can further have a user event processing function. If the received user events can be Android user events, the Android application proxy processing module 201 can process the events (e.g., foreground/background switching, etc.), and send the user interface information to the display module for display.

In another embodiment, the Linux application processing module 202 can receive the shared display information and user events sent from the Android application proxy processing module 201, display configuration, process the user events, and send user interface information that contains information on user event processing procedure and result to the display module 203.

In yet another embodiment, the display module 203 can receive and displays user interface information sent from the Linux application processing module 202 and Android application proxy processing module 201, respectively.

In some embodiments, the Linux system module 204 can receive user events and send user event notification information to the Android system module 205.

In some embodiments, the Android system module 205 can receive user event notification information sent from the Linux system module 204 and send the user event notification information to the Android application proxy processing module 201, or can receive user events and send the formed user event notification information to the Android application proxy processing module 201.

In the method and device for running Linux applications in Android system disclosed herein, an Android application proxy processing module can be utilized to create a shared display area as the shared display area for the results of Linux user event processing. The display of processing results of Linux user events and Android user events can be systematically managed by the Android application proxy processing module. The received Linux user events can be transmitted to a Linux application processing module for processing. Accordingly, the Linux applications can work normally in the Android system.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A device for running Linux applications in an Android system, the device comprising:
an Android application proxy processing module configured to:
connect with an Android system module and a Linux application processing module,
create a shared display area,
send shared display information based on the shared display area to the Linux application processing module,
receive user events sent from the Android system module, and
send the user events to the Linux application processing module;
a Linux application processing module configured to:
receive the shared display information and the user events from the Android application proxy processing module,
display configuration information,
process the user events, and
send user interface information to the display module;
a display module configured to receive and display the user interface information from the Linux application processing module or the Android application proxy processing module;
the Linux system module configured to receive the user events and transmit the received user events to the Android system module; and
the Android system module configured to transmit the received user events to the Android application proxy processing module.

2. The device of claim 1, wherein the Android application proxy processing module is configured to process the received Android user events and send the user interface information to the display module.

3. A method for running Linux applications in an Android system, the method comprising:
by a mobile computing system comprising computer hardware:
creating a shared display area using an Android application proxy processing module;
sending shared display information based on the shared display area from the Android application proxy processing module to a Linux application processing module;
receiving the shared display information with the Linux application processing module;
displaying configuration information using the Linux application processing module;
processing user events using the Linux application processing module; and
sending user interface information from the Linux application processing module to a display module.

4. The method of claim 3, wherein the displaying configuration information occurs according to shared display information sent from the Android application proxy processing module.

5. The method of claim 3, further comprising:
receiving user events sent from an Android system module with the Android application proxy processing module;
transmitting user events from the Android application proxy processing module to the Linux application processing module;
sending user interface information from the Linux application processing module to the display module according to the displayed configuration information; and
displaying user interface information using the display module.
